(19) United States
(12) Patent Application Publication
(10) Pub. No.: US 2009/0151814 A1
(43) Pub. Date: Jun. 18, 2009

(54) Dosing apparatus

(76) Inventors: John Joseph Kelly, Heckington (GB); Hendrik Fredrik Stoltz, Zurich (CH); Gert Lourens Jacobus Venter, Vanderbijlpark (ZA)

Correspondence Address: WARN, HOFFMANN, MILLER & LALONE, .P.C, PO BOX 70098, ROCHESTER HILLS, MI, 48307, US

(21) Appl. No.: 11/884,256

(22) PCT Filed: Feb. 9, 2006
(86) PCT No.: PCT/GB06/00456

§ 371 Date: Jun. 16, 2008

(30) Foreign Application Priority Data
Feb. 12, 2005 (GB) 0503019.2

(51) Int. Cl. B65B 1/04; B67C 3/28; F16K 41/10; G01F 11/30

(52) U.S. Cl. 141/286; 53/249; 222/547; 251/324

(57) ABSTRACT

A dosing apparatus in a form-fill-seal packaging machine comprises a delivery nozzle (12), a valve closure member (34) co-axial with the nozzle (12) and reciprocable co-axially relative thereto and bounding with the nozzle (12) an annular volume (35) therebetween for flow of liquid therethrough, fins (54) in the volume (35) and extending helically co-axially with the nozzle (12) for imparting a spiral motion to the liquid flowing through said volume, an annular valve closure seat (42) in and co-axial with the nozzle (12), respective annular portions of the seat (42) and the member (34) coming into sealing contact with each other, the annular portion of the member (34) comprising glass-fibre-reinforced plastics, a tubular bellows (44) extending between the nozzle (12) and the member (34) and sealingly separating in a liquid-tight manner the volume (35) from an interior chamber (46), and ducting (49, 50) which serves to supply a microbiocidal medium to the chamber (46).

This invention relates to a dosing apparatus.

A known dosing apparatus includes a fluidic piston-and-cylinder device having its cylinder fixed by columns and bolts to a flange of an upper end cap of a delivery nozzle of a filling station of a form-fill-seal packaging machine. The nozzle, which is of stainless steel, has an inlet pipe for the product, such as liquid food, to be filled. The inlet pipe is connected to a product-containing tank of the form-fill-seal machine, which tank is at a level higher than that of the piston-and-cylinder device and the nozzle. The piston rod is connected to a plunger which has, at its lower end, a valve closure element which is provided with a generally downwardly facing, annular shoulder portion arranged to come into sealing contact with a generally upwardly facing annular valve seat portion.

GB-A-828,243 discloses a spray gun suitable for fire extinguishing purposes, in which, in the nozzle of the gun, there is a set of flexible blades which, at their upstream ends, are fastened to a collar which is slidable along the barrel of the gun but not rotatable relative to the barrel and, at their downstream ends, are fastened to a collar which is not only slidable along the barrel but also turnable relative to the barrel, so that the angle of inclination of the blades can be altered as desired. Thus, the blades can be in a non-twisted condition in which the spray leaving the gun does not twist, or can be twisted clockwise or anti-clockwise, so that the exiting spray twists accordingly.

According to one aspect of the present invention, there is provided a packaging machine comprising a filling apparatus comprised of a delivery nozzle, a member substantially co-axial with said nozzle and reciprocable substantially co-axially relative thereto and bounding with said nozzle an annular volume therebetween for flow of flowable substance therethrough, and at least one fin in said volume and extending substantially spirally substantially co-axially with said nozzle for imparting a spiral motion to said flowable substance flowing through said volume.

Owing to this aspect of the invention, it is possible to ensure that the flowable substance is delivered obliquely to the axis of the nozzle, and thus to reduce the tendency for the flowable substance to rebound from a surface to which the substance is delivered by the nozzle, which surface is substantially perpendicular to the axis of the nozzle.

If the member is axially reciprocable in the nozzle, the fin can have the additional purpose of guiding the member.

According to a second aspect of the present invention, there is provided a dosing apparatus, comprising a delivery nozzle, an annular valve closure seat in and co-axial with said nozzle, a valve closure member substantially co-axial with said nozzle and reciprocable substantially co-axially relative thereto and bounding with said nozzle an annular volume therebetween for flow of flowable substance therethrough, and respective annular portions of said seat and said member for coming into sealing contact with each other, at least one of said annular portions comprising a material in the form of a mixture of plastics and silicon.

Owing to this aspect of the invention, since the silicon, which is preferably in the form of glass, gives the material a greater hardness than would be the case if the material were of the plastics alone, the or each annular portion comprised of the mixture in question tends to be better at holding its tolerances and thus promoting reliable sealing, particularly through being better at shearing solid particles of the flowable substance which are present between the respective annular portions of the seat and the member upon closing thereof.

According to a third aspect of the present invention, there is provided a dosing apparatus, comprising a delivery nozzle, a member substantially co-axial with said nozzle and reciprocable substantially co-axially relative thereto and bounding with said nozzle an annular volume therebetween for flow of flowable substance therethrough, a flexible wall extending between said nozzle and said member and substantially sealingly separating in a flowable-substance-tight manner said annular volume, which is at one side of said wall, from a second volume which is at the opposite side of said wall, and a device which serves to supply a microbiocidal medium to said second volume.

Owing to this aspect of the invention, it is possible to avoid any risk that micro-organisms might penetrate into the annular volume by way of the second volume and thus contaminate the flowable substance.

In order that the invention may be clearly and completely disclosed, reference will now be made, by way of example, to the accompanying drawings, in which:

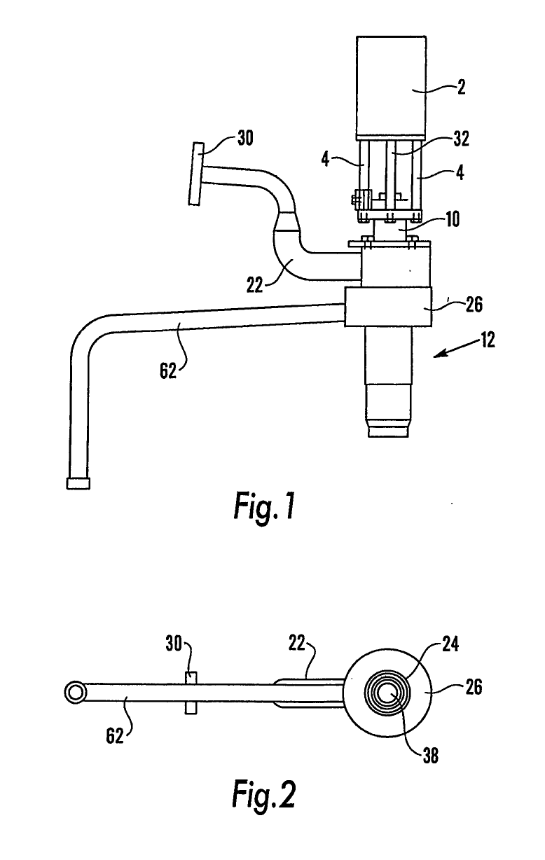

FIG. 1 is a side elevation of a dosing apparatus,

FIG. 2 is an underneath plan view thereof, and

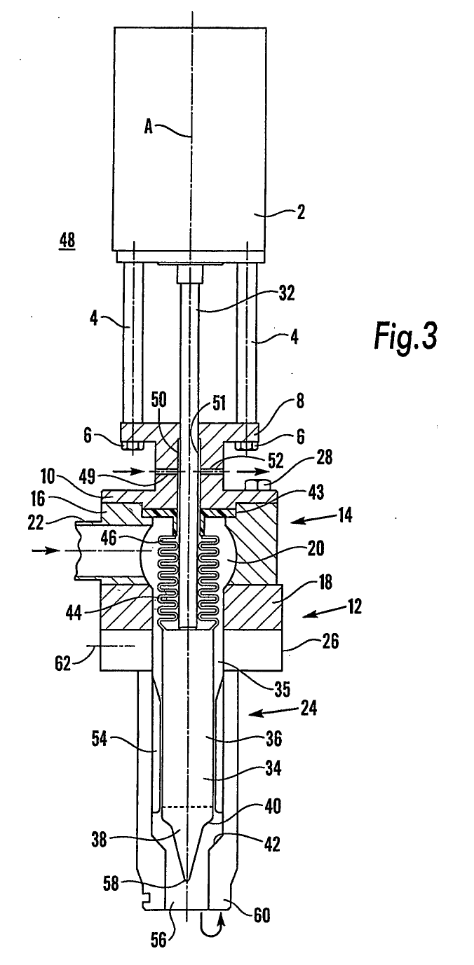

FIG. 3 is a diagrammatic side elevation, partly in vertical axial section, of part of the apparatus.

Referring to the drawings, the dosing apparatus includes a fluidic piston-and-cylinder device 2 having its cylinder fixed by columns 4 and bolts 6 to a flange 8 of an upper end cap 10 of a delivery nozzle 12 of a filling station of a form-fill-seal packaging machine. The nozzle 12, which is of stainless steel, also includes an intermediate, hollow part 14 comprised of two annuli 16 and 18, the upper one 16 of which bounds an inlet chamber 20 for the nozzle and provides the outlet of an inlet pipe 22 for the product, i.e. flowable substance, such as liquid food, to be filled. The nozzle 12 also includes a lower part 24 in the form of a double-walled sleeve having a double-walled top flange 26 which is fixed to the cap 10 and the part 14 by way of bolts (of which one is seen and referenced 28) distributed around the vertical, longitudinal axis A of the nozzle 12. The inlet pipe 22 is connected, by way of a flanged connector 30, to a product-containing tank of the form-fill-seal machine, which tank is at a level higher than that of the device 2 and the nozzle 12 such that the product is fed by only gravity to the pipe 22. A piston rod 32 is connected co-axially to a plunger 34 which is co-axial with the lower part 24 and which bounds with the part 24 an annular volume 35. The plunger 34 includes a circular cylindrical part 36 co-axial with the nozzle 12 and fixed at its upper end to the piston rod 32 and, at its lower end, to a valve closure element 38 which is provided with a generally downwardly facing, annular shoulder portion 40 arranged to come into liquid-tight sealing contact with a generally upwardly facing annular valve seat portion 42 of the inner wall of the double-walled, stainless steel, part 24. The cylindrical part 34 is of PTFE (polytetrafluoroethylene) whilst the part 38 is of glass-fibre-reinforced PTFE. The making of the part 38 of glass-fibre-reinforced PTFE means that the part 38 is harder, and thus better able to maintain its tolerances relative to the seat portion 42, than if it were to be made of PTFE alone. The relatively greater hardness means that the part 38 is better able to co-operate with the stainless steel portion 42 in shearing solid particles, for example in such food products as yoghurt containing fruit pieces, so that the portions 40 and 42 are better able to close in a liquid-tight manner. Attached in a liquid-tight manner around the upper end of the plunger 34 and having a top flange 43 thereof sealingly clamped between the cap 10 and the annulus 16 is a tubular bellows 44 of PTFE. The bellows 44 constitutes a flexible wall encircling the piston rod 32 and bounds at its outer side the inlet chamber 20 and the annular space 35 and, at its inner side, an interior chamber 46 which encircles the piston rod 32 which extends through the cap 10 by way of a co-axial bore 47. If the dosing apparatus is intended for aseptic filling, then, to reduce the risk that micro-organisms from the ambient atmosphere 48 might gain access, through the bore 47, to the sterilized product fed to the inlet pipe 22 in the dosing apparatus provision would be made for a superheated steam barrier to be established in the bore 47 and thus between the chamber 46 and the ambient atmosphere 48. This is achieved by continuously supplying a superheated steam/sterile gas (particularly air) mixture to a radial inlet bore 49 communicating with a longitudinal inlet channel 50 extending to the chamber 46 and leading that mixture from the chamber 46 via a diametrically opposite longitudinal outlet channel 51 and a radial outlet bore 52 for recirculation. The sterile gas may be air which is obtained from the ambient air by way of a micro-filter which is itself steam-sterilized. The mixture temperature at the outlet 52 is monitored by means of a thermocouple to enable an optimum temperature of the mixture to be maintained. This monitoring can also indicate whether the bellows 44 is continuing to provide a gas-tight seal. The same function can additionally or alternatively be provided by monitoring the pressure of the mixture at the outlet 52 by means of a pressure transducer. Fixed to the inner wall of the part 24 so as to be located in the annular volume provided by the annular space 36 are a plurality of fins 54 which, although not so shown in FIG. 3, are of a helical form co-axial with the axis A and so promote a swirling motion about the axis A of the product as it leaves the outlet 56 of the nozzle 12, so reducing its tendency to rebound from a liquid or solid surface onto which it is being delivered and which is perpendicular to the axis A. The element 38 terminates downwardly in a relatively sharp, anti-drip point 58, to reduce dripping from the valve closure plunger 34 following delivery of the desired dose. The amount to be dosed is controlled by opening and closing of the plunger 34 by the device 2, which is itself controlled by way of a microprocessor to which is supplied flow values measured by a flow meter (not shown) provided between the product-containing tank and the outlet of the pipe 22.

The dosing apparatus has provision for CIP (clean-in-place) employing chemical or steam sterilization. It is for this reason that the part 24 is made double-walled, so as to provide a CIP return inlet 60 encircling the outlet 56. To. achieve cleaning, a CIP cap is fitted over the lower end of the lower part 24, and subsequently a sterilant in the form of a suitable chemical or of superheated steam is supplied via the pipe 22 to the chamber 20 and the volume 35 and thence to the outlet 56 where the CIP cap directs the sterilant to the inlet 60 (as indicated by the arrow 61 in FIG. 3) whence it flows to a CIP return pipe 62 illustrated in FIGS. 1 and 2 and indicated diagrammatically at 62 in FIG. 3.

Among the advantages of the dosing device described with reference to the drawings are that it is relatively simple; in particular, there are no pumps or springs; the valve is opened and the product falls under gravity into the container. Moreover, it provides a continuous solid surface (except at the valve seat, of course) bounding the product therein; in particular, there are no sliding seals, which can permit entry of micro-organisms.

We claim:

1-18. (canceled)

19. A packaging machine comprising a filling apparatus comprised of a delivery nozzle, a member substantially co-axial with said nozzle and reciprocable substantially co-axially relative thereto and bounding with said nozzle an annular volume therebetween for flow of flowable substance therethrough, and at least one fin in said volume and extending substantially spirally substantially co-axially with said nozzle for imparting a spiral motion to said flowable substance flowing through said volume, wherein the or each fin is fixed relative to said nozzle.

20. A machine according to claim 19, wherein the or each fin serves to guide said member during the reciprocation of said member.

21. A machine according to claim 19, wherein said filling apparatus further comprises an annular valve closure seat in and co-axial with said nozzle, said member being a valve closure member, said seat and said member having respective annular portions for coming into sealing contact with each other, and at least one of said annular portions comprising a material in the form of a mixture of plastics and silicon.

22. A machine according to claim 21, wherein said material is glass-fibre-reinforced polytetrafluoroethylene.

23. A machine according to claim 21, wherein the annular portion of said member comprises said material.

24. A machine according to claim 23, wherein the other of said annular portions is of stainless steel.

25. A machine according to claim 21, wherein the other of said annular portions is of stainless steel.

26. A machine according to claim 19, wherein said filling apparatus further comprises a flexible wall extending between said nozzle and said member and substantially sealingly separating in a flowable-substance-tight manner said annular volume, which is at one side of said wall, from a second volume which is at the opposite side of said wall, and a supplying device which serves to supply a microbiocidal medium to said second volume.

27. A machine according to claim 26, wherein said medium is a superheated steam/sterile gas mixture.

28. A dosing apparatus comprising a delivery nozzle, an annular valve closure seat in and co-axial with said nozzle, a valve closure member substantially co-axial with said nozzle and reciprocable substantially co-axially relative thereto and bounding with said nozzle an annular volume therebetween for flow of flowable substance therethrough, and respective annular portions of said seat and said member for coming into sealing contact with each other, at least one of said annular portions comprising a material in the form of a mixture of plastics and silicon, wherein the other of said annular portions is of stainless steel.

29. A dosing apparatus according to claim 28, wherein said silicon is in the form of glass.

30. A dosing apparatus according to claim 29, wherein said material is glass-fibre-reinforced plastics.

31. A dosing apparatus according to claim 28, wherein said plastics is polytetrafluoroethylene.

32. A dosing apparatus comprising a delivery nozzle, a member substantially co-axial with said nozzle and reciprocable substantially co-axially relative thereto and bounding with said nozzle an annular volume therebetween for flow of flowable substance therethrough, a flexible wall extending between said nozzle and said member and substantially sealingly separating in a flowable-substance-tight manner said annular volume, which is at one side of said wall, from a second volume which is at the opposite side of said wall, and a device which serves to supply a microbiocidal medium to said second volume.

33. A dosing apparatus according to claim 32, wherein said medium is a superheated steam/sterile gas mixture.
